(19) United States
(12) Patent Application Publication
(10) Pub. No.: US 2010/0102155 A1
(43) Pub. Date: Apr. 29, 2010

(54) Fixed Quantity Supply Apparatus for Breaking Open Waste Envelope

(75) Inventor: Kyoung Duk Na, Gunpo-si (KR)

Correspondence Address: THE WEBB LAW FIRM, P.C., 700 KOPPERS BUILDING, 436 SEVENTH AVENUE, PITTSBURGH, PA, 15219, US

(73) Assignee: FORCEBEL CO., LTD., Hwaseong-si (KR)

(21) Appl. No.: 12/531,827

(22) PCT Filed: Mar. 19, 2008
(86) PCT No.: PCT/KR08/01543

§ 371 Date: Sep. 17, 2009

(30) Foreign Application Priority Data
Mar. 20, 2007 (KR) 10-2007-0027254

(51) Int. Cl. B02C 15/00

(52) U.S. Cl. 241/107

(57) ABSTRACT

A waste steady-supply apparatus, including: an input hopper for transferring waste envelopes introduced from outside to a waste envelope breaking device; a break-supply assembly that is steadily and continuously breaking the waste envelopes open; and a cutting assembly for additionally cutting and discharging the waste envelope which has not broken enough by the break-supply assembly.

### TECHNICAL FIELD

The invention relates generally to waste envelope processing devices, and more particularly, to a waste envelope breaking mechanism for a waste steady-supply apparatus wherein waste envelopes containing life waste materials out from homes supplied by an input conveyor are broken open and lugged up steadily and continuously by break blade members on a polygonal rotatable drum, the break blade members popping up and down above the polygonal rotatable drum, small waste bags and big waste materials mixed in the broken waste envelops being cut additionally and discharged to an output conveyor.

### BACKGROUND ART

Generally, in every-day life, life waste materials as food waste, paper, plastic etc generated. Among the life waste materials, reusable waste materials is put in waste envelopes, for example, as standard plastic garbage bags, which are provided by local authorities and have standard sizes, then transferred to waste processing sites and then recycled as industrial energy source or buried at landfills.

At the processing site, reusable waste materials among wastes first may be broken down to small pieces, then for example metal components may be sorted and removed from the wastes by magnetic forces or other screening process, after that may be formed as solid fuels called as RDF (Refuse Derived Fuel).

Besides, the life waste envelopes processed in said break down processing could contain many kinds of solid and hard materials such as rocks, wall stones, metals etc. So before the processing, to avoid breaking device's cutting blades to be broken or worn, workers break open these wastes envelopes manually so causing delay of the processing time.

Although, to solve the problems, many devices for breaking the wastes envelopes open have been developed, these conventional devices have problems that it is too difficult to processing massive quantity of the wastes. Moreover, the processed wastes materials discharged for further processing still contained unbroken small waste bags mostly because the processed waste materials would be inserted in or curled up or entangled with the parts of the devices. Therefore, workers must break open these unbroken small waste bags manually before introduce it further processing, still causing delay of the processing time.

### DISCLOSURE OF INVENTION

Therefore, the invention is to solve above mentioned conventional problems, the object of the invention is that provides a waste envelope breaking mechanism for a waste steady-supply apparatus wherein massive quantity of waste envelops could be processed in short processing time, whereby the waste envelopes containing life waste materials supplied is broken open and lugged up steadily and continuously by break blade members on a polygonal rotatable drum, the break blade members popping up and down above the polygonal rotatable drum, small waste envelops and big waste materials mixed in the broken waste envelops being cut additionally by the cutting assembly, and the processed waste envelopes is discharged to the output conveyor.

To accomplish said object, the invention is characterized by comprising that an input hopper for collecting waste envelopes containing waste materials, mounted between inner support members that supported by support plates; a break-supply assembly that is continuously cutting and at the same time lugging the waste envelopes upward at relatively constant quantity, the waste envelopes have been transmitted by a transfer conveyor installed at the lower part of the input hopper; and a cutting assembly for secondly cutting the waste envelopes which have been lugged up by the break-supply assembly, and for discharging it onto an output conveyor.

In a desired embodiment, the break-supply assembly 30 is comprising of, a plurality of cams axis-fixed side by side at same intervals on a cam shaft 32 between outer support members; a rotatable drum that the cam shaft horizontally penetrates the central area of it, which is mounted rotatably on its axis, and which has a polygon-shaped circumference surface; a plurality of break blade members for steadily cutting and at the same time lugging the waste envelope to the area of the cutting assembly, each of which is installed in the polygon-shaped circumference surface of the rotatable drum alternatively, the upper part of it can pop in and out outside of the polygon-shaped circumference surface of the rotatable drum, and the lower part of it selectively sticks to the outer surface of the cam; and a rotate means which is rotatably axis-fixed to the cam shaft at a side of the rotatable drum to rotate the rotatable drum.

The invention provides effects that massive quantity of waste envelops could be processed in short processing time, whereby the waste envelopes containing life waste materials supplied is broken open and lugged up steadily and continuously by break blade members on a polygonal rotatable drum, the break blade members popping up and down above the polygonal rotatable drum, small waste envelops and big waste materials mixed in the broken waste envelops being cut additionally by the cutting assembly, and the processed waste envelopes is discharged to the output conveyor.

### DESCRIPTION OF DRAWINGS

FIG. 1 is a diagrammatic view of the general structure for a waste envelope breaking mechanism for a waste steady-supply apparatus according to the invention;

FIG. 2 is a front view of FIG. 1;

FIG. 3 is a sectional view illustrating a break-supply assembly of the waste envelope breaking mechanism for a waste steady-supply apparatus according to the invention;

FIG. 4 is a sectional view of FIG. 3;

FIG. 5 is an exploded oblique view illustrating a break-supply assembly of the waste envelope breaking mechanism for a waste steady-supply apparatus according to the invention;

FIG. 6 is an oblique view illustrating a cutting assembly of the waste envelope breaking mechanism for a waste steady-supply apparatus according to the invention;

FIG. 7 is an operational view illustrating the break-supply assembly and the cutting assembly of the waste envelope breaking mechanism for a waste steady-supply apparatus according to the invention; and

FIG. 8 is a general operational view illustrating the waste envelope breaking mechanism for a waste steady-supply apparatus according to the invention.

### BEST MODE

The accompanying drawings illustrate example embodiments of the present invention. Example embodiments may, however, be embodied in different forms and should not be considered as limited to the embodiments set forth in the drawings. Rather, these embodiments are provided so that this disclosure will be thorough and complete, and will fully convey the scope of the invention to those skilled in the art.

Therefore, the example in this specification and the construction illustrated on the drawings is only one desirable example of this invention and does not represent all the technical ideas of this invention. There can be various equivalents and variations of this invention at the time of this application.

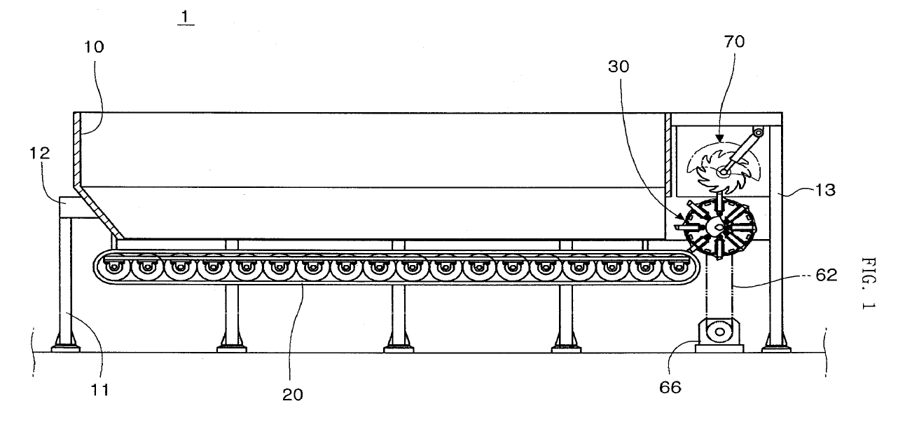

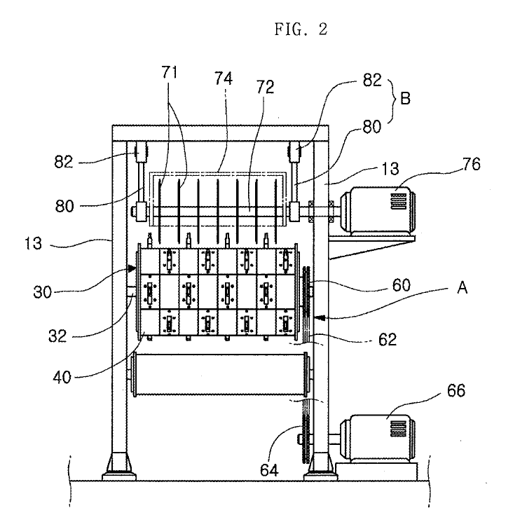

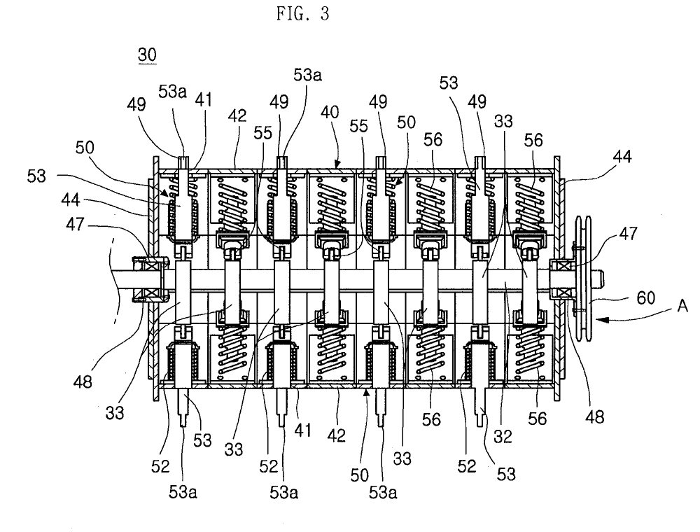

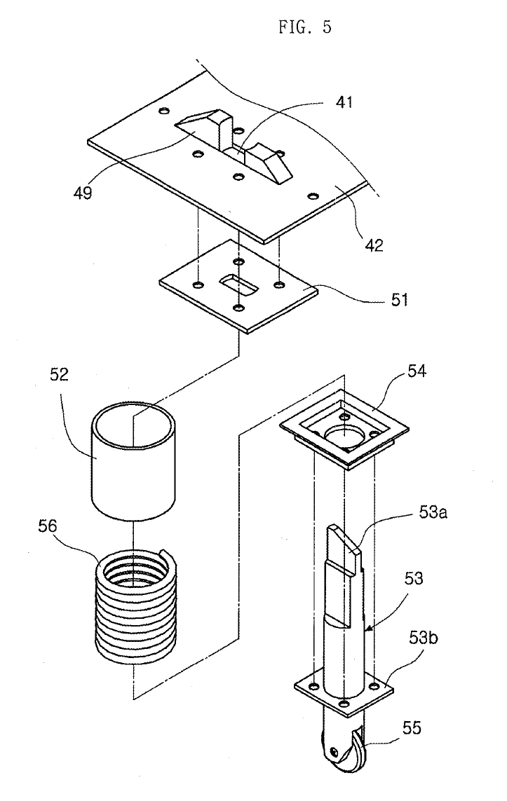

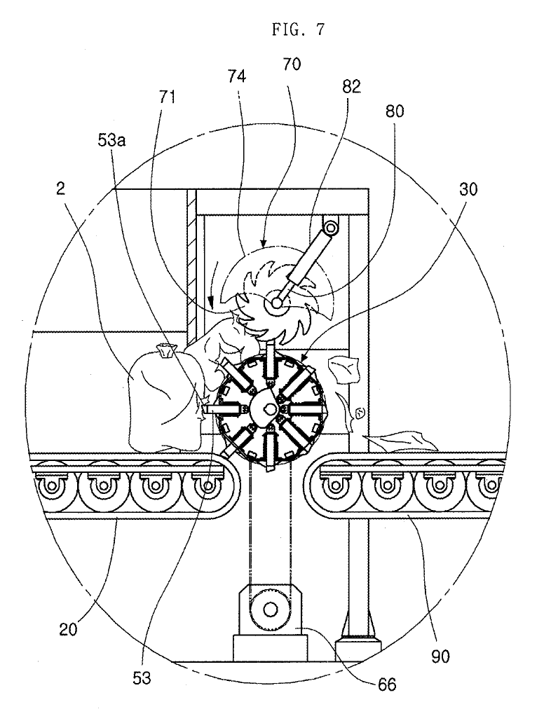

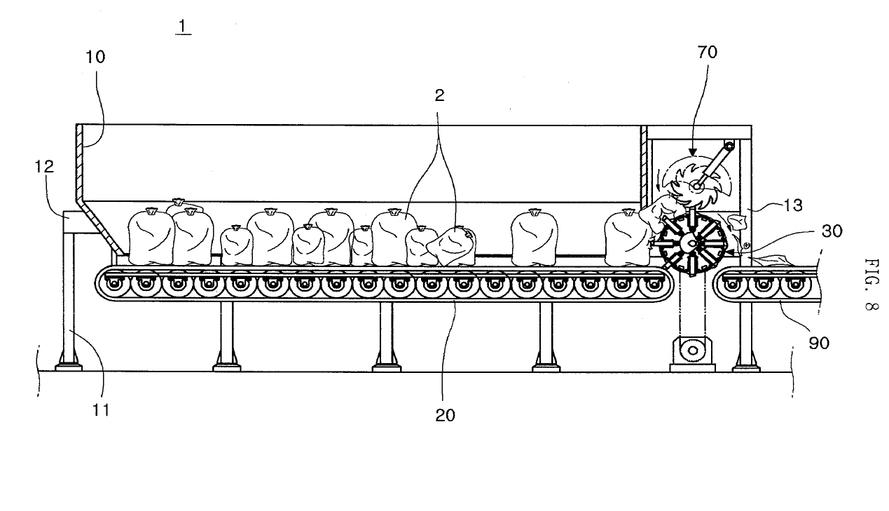

As showed in FIGS. 1 to 8, a waste envelope breaking mechanism for a waste steady-supply apparatus 1 according to in invention, may be comprised by: an input hopper 10 for collecting waste envelopes 2 containing life waste materials etc.; a transfer conveyor 20 for transferring the waste envelopes 2 collected by the input hopper 10 to a side direction; a break-supply assembly 30 that is steadily and continuously cutting and at the same time lugging the waste envelopes 2 at relatively constant quantity upward, the waste envelope 2 has been transmitted by a transfer conveyor 20; and a cutting assembly 70 for secondly cutting the waste envelopes 2 supplied by the break-supply assembly 30.

And an output conveyor 90, installed at the lower area of the cutting assembly 70, could rapidly discharge the waste materials of the broke-opened waste envelops 2 to a next step of waste processing.

The input hopper 10 may be mounted between inner support members 12 that supported by support plates 11 at a suitable height from the floor, and collects the waste envelops 2 of suitable quantity inside of it.

The transfer conveyor 20 may be installed at the lower part of the input hopper 10, and transfers slowly the waste envelopes 2 supplied by the input hopper 10 to a side direction, that is, to the break-supply assembly 30.

The break-supply assembly 30 may be comprised by: a plurality of cams 33 axis-fixed side by side at same intervals on a cam shaft 32 between outer support members 13, the outer support members 13 is installed opposite side of the inner support members 12; a rotatable drum 40 that the cam shaft 32 horizontally penetrates the central area of it, which is mounted rotatably on its axis, and which has a polygon-shaped circumference surface; a plurality of break blade members 50 for steadily cutting and at the same time lugging the waste envelope 2 to the area of the cutting assembly 70, each of which is installed in the polygon-shaped circumference surface of the rotatable drum 40 alternatively, the upper part of it can pop in and out outside of the polygon-shaped circumference surface of the rotatable drum 40, and the lower part of it selectively sticks to the outer surface of the cam 33; and a rotate means A which is rotatably axis-fixed to the cam shaft 32 at a side of the rotatable drum 40 to rotate the rotatable drum 40.

In here, the cam 33 may be shaped to form a circular arc at a side of it and a mushroom shape at the opposite side so that the break blade members 50 have different radial moving lengths.

The rotatable drum 40 may be comprised by: horizontal portions 42 of circumference surface of the rotatable drum 40, being an octagon shape of a suitable fixed length, each horizontal portion 42 having a vertical opening 41, these vertical openings 41 are alternatively formed in the octagonal circumference surface; vertical end portions 44 connected to and fixed to both ends of the horizontal portions 42; rotate members 48, each of which rotatably connected with bearing 47 to the cam shaft 32 at the central area of the vertical ending portion 44, and connected to and fixed to the vertical ending portion 44.

In here, each of blade guides 49 may be formed on the circumference of the vertical openings 41 at outside of the horizontal portions 42. Upper portion of the blade guide 49 have same shape as the end portion of a blade tip 53, which will be stated later, of the break blade member 50.

The break blade member 50 may be comprised by: a upper plate 51 connected to and fixed to the inner face of the horizontal portion 42 so that an opening of the upper plate 51 corresponds the vertical opening 41 in the horizontal portion 42; a lower connecting cylinder 52 fixed to the inner face of the upper plate 51 so as to protrude downward; a break blade 53 inserted inside the vertical opening 41, the upper plate 51 and the lower connecting tube 52 so as to pop in and out upward and downward, the break blade 53 has a blade tip 53a at upper area of it and a lower plate 53b at lower area of it; a lower support member 54 connected to and fixed to the lower plate 53b of the break blade 53; a transfer roller 55 rotatably mounted in the lower end of the break blade 53 so as to moving along the circumference surface of the cam 32; an elastic spring 56 inserted in the lower connecting cylinder 52, touched and at the same time fixed by the upper plate 51 and the lower support member 54 at its upper and lower ends so as to support elastically the break blade 53 when it moves upward and downward.

The rotate means A may be comprised by: an upper sprocket 60 connected to and fixed to the rotate member 48, having the cam shaft 32 axis-fixed to the central area of it; a drive motor 66 having a lower sprocket 64 axis-fixed to it, the lower sprocket 64 is connected to the upper sprocket 60 by a chain 62.

In here, the drive motor 66 could be operated in retro-direction by a sensor(not shown) which senses the in-direction operation of the drive motor 66 had not easily worked because, for example, the debris of processed wastes had inserted between the break blades 53 and the circumference of the rotatable drum 40.

The cutting assembly 70 may be comprised by: a horizontal rotate shaft 72 axis-fixed rotatably between the outer support members 13 in the upper area of the break-supply assembly 30, the horizontal rotate shaft 72 has a plurality of cut blades 71 axis-fixed at its circumference surface; a cut blade safety cover 74, which both end portion inserted to and fixed to the horizontal rotate shaft 72, protecting the cut blades 71 inside area of its half circular surface; a support means B installed at between both end of the cut blade safety cover 74 and the upper portion of the outer support member 13 so as to support the cut blade safety cover 74; and a motor 76 rotating the cut blades 71, the motor 76 connected to an end of the horizontal rotate shaft 72 and mounted on the outer support member 13.

In here, it is desired that the cut blades 71 is shaped to break the waste envelopes 2 open easily, and the motor 76 controls the rotate direction of the cut blades 71 is opposite with to the rotate direction of the break-supply assembly 30.

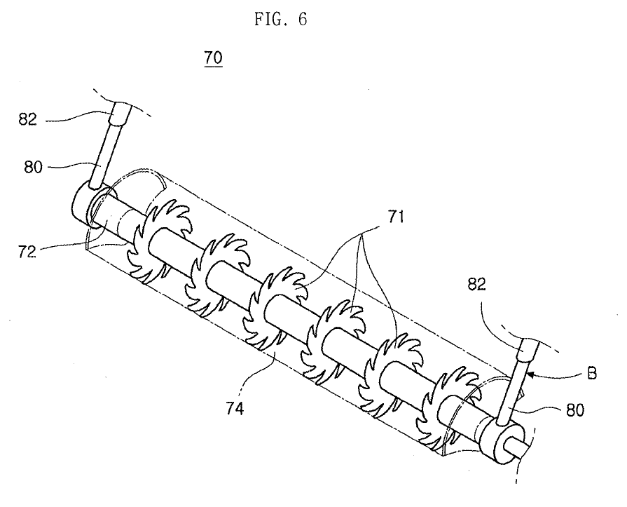

Now, operations of the invention comprised as such will be stated. As shown in FIG. 6, waste envelopes 2 containing life waste materials etc. could be transmitted by some transmit means and collected at suitable quantity in the input hopper 10 of the waste envelope breaking mechanism for a waste steady-supply apparatus 1.

The collected waste envelopes 2 are supplied to the transfer conveyor 20 at the lower area of the input hopper 10. Then, the waste envelopes 2 are transferred on the transfer conveyor 20 to the area of the break-supply assembly 30, where the waste envelopes 2 are steadily and continuously cut firstly and at the same time lugged upward to the area of the cutting assembly 70.

More specifically, as shown in FIG. 6, when the waste envelops 2 supplied along the transfer conveyor 20, the break-supply assembly 30 operates by the rotate mean A, and then the rotatable drum 40 rotates in-direction, that is clockwise direction.

That is, when the drive motor 66 operates, the driving force of the drive motor 66 can be transmitted to, in turn, the lower sprocket 64, the chain 62, and the upper sprocket 60, and as a result the rotate member 48 at a side of the vertical end portion 44 of the rotatable drum 40 could rotate. Then the rotatable drum 40 could be rotated in-direction wherein the cam shaft 32 is axis-fixed to the opposite side of the inner support members 12.

Accordingly, the transfer rollers 55, each of which is mounted in the lower end of the break blade 53 which had inserted inside the vertical opening 41, the upper plate 51 and the lower connecting tube 52 so as to pop in and out upward and downward, could rotate and move along the circumference surface of the cams 32 one after the others.

In here, each of the cam 33 may be shaped to form a circular arc at a side of it and a mushroom shape at the opposite side so that the break blades 53 have different moving lengths of the up and down directions.

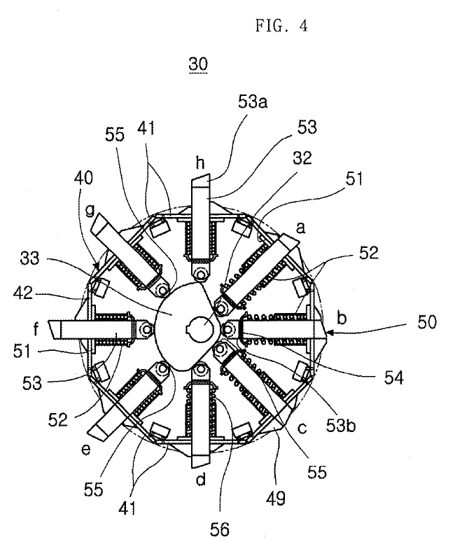

Now as shown in FIG. 4, the blade tip 53a of the break blade 53 comprising the break blade member 50, for example, starts to pop out at the position d, in turn, position e, position f, position g, and then position h.

In this case, the transfer roller 55 at the lower part of the break blade 53, moves along the circular arc part of, that is the circumference surface part having the most radial length of the cam 32. And the elastic spring 56 fixed by the upper plate 51 and the lower support member 54 of the break blade 53 at its upper and lower ends, is pressed to its least length. As a result, the blade tip 53a, i.e. the upper end of the break blade 53 pops and moves out to the highest position from the vertical openings 41 of the rotatable drum 40.

When the break blade 53 pops and moves out, the blade tip 53a of the break blade 53 breaks the waste envelope 2 open, then the broken materials steadily and continuously can be entangled with the rotatable drum 40 shaped as polygon-form (for example, as octagon-form) and with the break blades 53 alternatively positioned and popped out, and can be lugged up to the area of the cutting assembly 70 by the rotate of the rotatable drum 40.

And then, the blade tip 53a of the break blade 53 comprising the break blade member 50, starts to move in at the position a, in turn, at position b and position c, where the blade tip 53a of the break blade 53 positions inside of the blade guide 49.

Accordingly, the wastes lugged upward may be not interfered by the break blade 53 so as to be discharged down to the output conveyor 90.

In this case, the transfer roller 55 at the lower part of the break blade 53, moves along opposite part of the circular arc part. And the elastic spring 56 fixed by the upper plate 51 at its upper end and the lower support member 54 of the break blade 53 at its lower end, is extended to its longest length. As a result, the blade tip 53a, that is, the upper end of the break blade 53 positions and hides inside the blade guide 49.

Besides, among the wastes lugged upward to the area of the cutting assembly 70, large or long waste materials and/or unbroken small waste bags could be completely cut by the cutting assembly 70 wherein the horizontal rotate shaft 72 is driven by the rotating force from the motor 76 and rotates in opposite direction with the break-supply assembly 30.

That is, when the horizontal rotate shaft 72 axis-fixed rotatably between the outer support members 13 in the upper area of the break-supply assembly 30 rotates, the cut blades 71 completely cut large or long waste materials and/or unbroken small waste bags among the wastes lugged upward. And these completely processed wastes could be discharged down on the output conveyor 90 without scattering around, by the cut blade safety cover 74 shaped as half circular form, which both end portion inserted to and fixed to the horizontal rotate shaft 72.

In here, for supporting the cutting assembly 70, a support means B is provided, the support means B may have a piston 80 and a hydraulic cylinder device 82 at upper part of the outer support member 13 and at both sides of the cut blade safety cover 74.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

### INDUSTRIAL APPLICABILITY

As dictated above, the invention provides economically beneficial effects that massive quantity of waste envelops could be processed with a few workers and short work times, by fast processing that the waste envelops, containing life waste materials supplied by a conveyor below the input hopper, is broken open and lugged up steadily and continuously by break blade members, the break blade members rotates when a polygonal rotatable drum rotates and moving up and down along the circumference surface of cams, small waste envelops and big waste materials mixed in the broken waste envelops is cut additionally by the cutting assembly which is rotating in direction of the transfer direction of the broken waste envelops, the cutting assembly ensures that the waste envelops has cut completely, and the processed waste envelopes is discharged to the output conveyor.

1. A waste envelope breaking mechanism for a waste steady-supply apparatus, comprising:
an input hopper for collecting waste envelopes containing waste materials, mounted between inner support members supported by support plates;
a break-supply assembly that is continuously cutting and at the same time lugging the waste envelopes upward at relatively constant quantity, the waste envelopes have been transmitted by a transfer conveyor installed at the lower part of the input hopper; and
a cutting assembly for secondly cutting the waste envelopes which have been lugged up by the break-supply assembly, and for discharging it onto an output conveyor.

2. The waste envelope breaking mechanism of claim 1, wherein the break-supply assembly comprises:
a plurality of cams axis-fixed side-by-side at same intervals on a cam shaft between outer support members;
a rotatable drum having a central area through which the cam shaft horizontally penetrates, which is mounted rotatably on its axis, and which has a polygon-shaped circumference surface;
a plurality of break blade members for steadily cutting and at the same time lugging the waste envelope to the area of the cutting assembly, each of which is installed in the polygon-shaped circumference surface of the rotatable drum alternatively, the upper part of it can pop in and out outside of the polygon-shaped circumference surface of the rotatable drum, and the lower part of it selectively sticks to the outer surface of the cam; and
a rotate means which is rotatably axis-fixed to the cam shaft at a side of the rotatable drum to rotate the rotatable drum.

3. The waste envelope breaking mechanism of claim 2, wherein the cam is shaped to form a circular arc at a side of it and a mushroom shape at the opposite side so that the break blade members have different radial moving lengths.

4. The waste envelope breaking mechanism of claim 2, wherein the rotatable drum includes:
a polygonal circumference surface having sub-surfaces, each sub-surface is a horizontal portion having a vertical opening, the vertical openings alternatively formed in the horizontal portions;
vertical end portions fixed to both ends of the circumference surface;
rotate members, each of which rotatably connected with bearing to the cam shaft at the central area of the vertical ending portion, and connected to and fixed to the vertical ending portion; and
blade guides, each of which is formed by guides on both sides of the vertical openings outside of the horizontal portions.

5. The waste envelope breaking mechanism of claim 4, wherein each of the break blade members comprises:
an upper plate connected to and fixed to the inner face of the horizontal portion so that an opening of the upper plate corresponds the vertical opening in the horizontal portion;
a lower connecting cylinder fixed the inner face of the upper plate so as to protrude downward;
a break blade inserted inside the vertical opening, the upper plate and the lower connecting tube so as to pop in and out upward and downward, the break blade has a blade tip at an upper area thereof and a lower plate at a lower area thereof;
a lower support member connected to and fixed to the lower plate of the break blade;
a transfer roller rotatably mounted in the lower end of the break blade so as to moving along the circumference surface of the cam; and
an elastic spring inserted in the lower connecting cylinder, touched and at the same time fixed by the upper plate and the lower support member at its upper and lower ends so as to support elastically the break blade when it moves upward and downward.

6. The waste envelope breaking mechanism of claim 1, wherein the cutting assembly comprises:
a horizontal rotate shaft axis-fixed rotatably between the outer support members in the upper area of the break-supply assembly, the horizontal rotate shaft has a plurality of cut blades axis-fixed at its circumference surface;
a cut blade safety cover, which both end portion inserted to and fixed to the horizontal rotate shaft, protecting the cut blades inside area of its half circular surface;
a support means installed at between both end of the cut blade safety cover and the upper portion of the outer support member so as to support the cut blade safety cover; and
a motor rotating the cut blades, the motor connected to an end of the horizontal rotate shaft and mounted on the outer support member.
